(19) United States
(12) Patent Application Publication
(10) Pub. No.: US 2021/0197987 A1
(43) Pub. Date: Jul. 1, 2021

(54) Systems and Methods for Adjusting the Orbit of a Payload

(71) Applicant: MOMENTUS INC., Santa Clara, CA (US)

(72) Inventors: Mikhail Kokorich, Santa Clara, CA (US); Joel Sercel, Santa Clara, CA (US)

(21) Appl. No.: 16/775,084

(22) Filed: Jan. 28, 2020

Related U.S. Application Data
(60) Provisional application No. 62/956,144, filed on Dec. 31, 2019.

(51) Int. Cl. B64G 1/00; B64G 1/24; B64G 1/36; G05D 1/00

(52) U.S. Cl. CPC B64G 1/007; B64G 1/242; G05D 1/0094; B64G 1/365; B64G 1/244; B64G 1/363

(57) ABSTRACT

To efficiently delivering payloads to respective orbits, a payload is received from a launch vehicle at a spacecraft operating as an orbital transfer vehicle. The payload is transferred, using the spacecraft, to a second orbit in accordance with a predefined fixed schedule that specifies at least the second orbit and a plurality of times at which the spacecraft transitions between the first and the at least second orbit.

### CROSS-REFERENCE TO RELATED APPLICATION

The present application is a non-provisional application claiming priority to U.S. Provisional Patent Application No. 62/956,144, filed on Dec. 31, 2019 titled “Systems and Methods for Adjust the Orbit of a Payload,” the disclosure of which is incorporated herein by reference in its entirety for all purposes.

### FIELD OF THE DISCLOSURE

The present disclosure relates to man-made spacecraft and other space vehicles and their orbital positioning.

### BACKGROUND

As known in the satellite industry, a sun synchronous orbit (SSO) is synchronous orbit is a nearly polar orbit around a planet, such as Earth, in which the satellite or other spacecraft passes over any given point of the Earth's surface at the same local mean solar time. More technically, it is an orbit arranged so that it precesses through one complete revolution each year, thereby maintaining the same relationship with the sun. Precession is a change in the orientation of the rotational axis of a rotating body. In other words, if the axis of rotation of a body is itself rotating about a second axis, that body is said to be precessing about the second axis. In astronomy, precession refers to any of several slow changes in an astronomical body's rotational or orbital parameters. An important example is the steady change in the orientation of the axis of rotation of the Earth, known as the precession of the equinoxes.

Certain SSOs are useful for imaging because every time that the satellite is overhead, the surface illumination angle on Earth underneath it will be nearly the same. This consistent lighting is a useful characteristic for satellites that image the Earth's surface in the visible or IR wavelength. However, other orbits are useful for other purposes. In choosing an orbit or sub orbit, the maximum sunlight time is considered as well as consistent orbital dynamics (meaning that the same angle is maintained with respect to the sun).

In a sun synchronous orbit, the various orbits and sub orbits are often represented in a simplified manner as the hours of a clock face. Thus, there are primary SSOs at 12 a.m., 6 a.m., 9 a.m., 12 p.m., 3 p.m., 6 p.m. and 9 p.m. However, there are also sub orbits (e.g. 11 a.m. or 1 a.m., etc.) that may be conveniently represented by the other hours on a clock face. In a clock representation, the hours on a clock are simply a proxy for the longitude on the Earth which the orbit traces on the Earth as it circles.

Satellites and other spacecraft and space vehicles are often placed into an SSO by a launch vehicle (LV). As noted above, the particular orbit is chosen in accordance with the use case or purpose of the satellite. For example, in a communications system, which typically comprises a constellation of satellites, the satellites may be placed at a plurality of orbits in the sun synchronous “clock.” In another use case, where the purpose of a satellite is for imaging, 9 a.m. is perhaps the most common or most popular orbit because of the maximum sunlight time. 6 p.m. is also a popular orbit for this purpose.

Thus, launch vehicles (LV) having payloads (PL) intended for these applications will typically place the spacecraft into one of the more common or more popular orbits which are in the greatest demand. Because of the cost, launch vehicles rarely travel to other primary orbits and rarely if ever travel to SSO sub orbits. Such payloads are placed into orbit, as noted above, by a launch vehicle. In a small LV envelope, only a single or primary payload is delivered into orbit. In a larger launch vehicle, a plurality of payloads can be placed into orbit. This is sometimes referred to as a “rideshare” LV service.

A larger launch vehicle is typically equipped with some form of adapter for attaching a payload. In one common arrangement, an ESPA ring is utilized. Such ESPA rings are well known for launching secondary payloads on orbital launch vehicles. These rings are provided with 6 ports; therefore, 6 secondary payloads can be attached to the ring. Moreover, in larger launch vehicles and ride share programs, a number of ESPA rings can be stacked one on top of another. Thus, a technical problem exists in the fact that present launch vehicles typically deliver their primary payloads, as well as all secondary payloads, to the same orbit. This is because it is economically impractical to deliver individual payloads to different SSO orbits or sub orbits.

### SUMMARY

Embodiments of the present disclosure provide systems and methods for adjusting or otherwise altering the initial orbit of a payload so that it can be placed into a different, final orbit. Thus, for example, a payload which is initially delivered by an LV to an SSO of 9 a.m. or 6 p.m., which are common SSOs, can be readily and economically transferred to other desired sub orbits such as 10 a.m. or 11 am, etc.

In addition, such orbital transfers can be maintained on a regular or fixed schedule, which may utilize a fixed route and timetable. Therefore, it is now economical to transfer or adjust orbits of payloads in a non-customized manner. Moreover, at various locations in orbit, a “spaceport” or other space depot can be maintained for the origination of such regularly scheduled payload flights. For example, in one embodiment, a depot might be located in a low earth orbit (LEO) having a zero degree inclination. Such a depot can provide propellant for the transfer vehicle, as well as a shared power supply and docking apparatus. In other words, such depots can maintain a shuttle service to transfer payloads from an initial orbit to a final or ultimate orbit. The shuttle service may transfer a payload from one LEO orbit to a higher LEO. In one embodiment, it may take several months to raise a payload from 300 km to 1,500 km.

In some embodiments, the advantages of the present systems and methods are achieved by use of an orbit transfer vehicle (OTV). In some embodiments, such a vehicle is provided with an integrated power source and thruster for payload transfer. In this regard, it will be understood that a payload comprises any type of payload, including without limitation those described above as well as primary, secondary, or tertiary payloads, whether mounted to adapter rings or delivered to an initial SSO or other LEO in some other fashion. Thus, the OTV is provided with an appropriate payload attachment adapter and is mounted, prior to launch or thereafter, to the payload. If mounted at launch, the OTV is positioned within the small LV envelope or ESPA envelope. Therefore, following deployment of the payload from the launch vehicle, the OTV acts as a shuttle to transfer the payload to its ultimate orbit or sub orbit.

One example embodiment of these techniques is a method for efficiently delivering payloads to respective orbits. The method includes receiving, at a spacecraft operating as an orbital transfer vehicle, a payload from a launch vehicle; and transferring the payload, using the spacecraft, to a second orbit in accordance with a predefined fixed schedule that specifies at least the second orbit and a plurality of times at which the spacecraft transitions between the first and the at least second orbit.

Another example embodiment of these techniques is a spacecraft comprising a thruster and a controller configured to implement the method above.

Another example embodiment of these techniques is a method for providing a propellant to a spacecraft in space. The method includes providing a depot including a propellant tank; causing the depot to be in a first orbit; and providing, at the depot to a spacecraft transferred to the first orbit by a launch vehicle, access to the propellant tank.

### BRIEF DESCRIPTION OF THE DRAWINGS

FIG. 1 is a block diagram of an example spacecraft configured for transferring a payload between orbits.

FIG. 2 is a schematic illustration of a clock face representing various sun-synchronous orbits and sub orbits.

FIG. 3 is a schematic illustration of the payload envelope of a launch vehicle and further illustrating a schematic orbit transfer vehicle according to one embodiment.

FIG. 4 is a schematic illustration of a portion of an ESPA ring including one port on the ring for attachment of a secondary payload, and further including a schematic illustration of one embodiment of an orbit transfer vehicle.

FIG. 5 is a schematic illustration of an orbit transfer vehicle and its attached payload during orbital transfer.

FIG. 6 is a table of typical mission scenarios describing orbital transfer parameters.

FIG. 7 is a flow diagram illustrating certain methods for transferring payloads from one orbit to another.

FIG. 8 is a schematic illustration of an ESPA ring or other payload adapter with an integrated water tank for propellant used by the OTV.

FIG. 9 is a top plan view of an ESPA ring or other payload ring adapter illustrating 6 payload ports and attached payloads, as well as a water storage tank in the middle of the ring for propellant to be used by the OTV.

### DETAILED DESCRIPTION

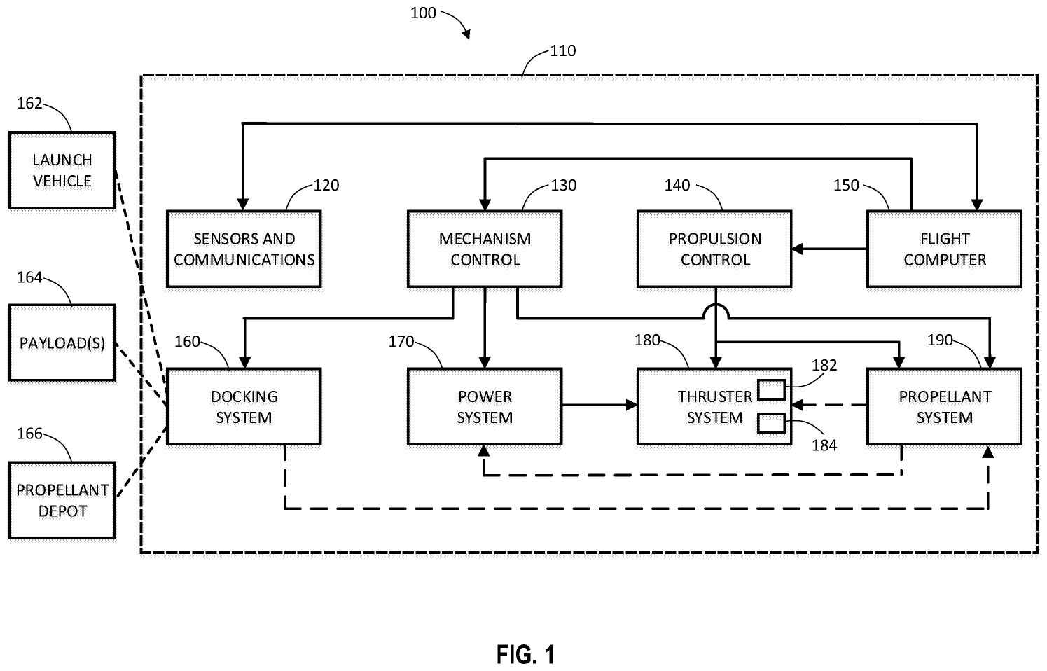

FIG. 1 is a block diagram of a spacecraft 100 configured for transferring a payload between orbits. The spacecraft 100 includes several subsystems, units, or components disposed in or at a housing 110. The subsystems of the spacecraft 100 may include sensors and communications components 120, mechanism control 130, propulsion control 140, a flight computer 150, a docking system 160 (for attaching to a launch vehicle 162, one or more payloads 164, a propellant depot 166, etc.), a power system 170, a thruster system 180 that includes a first thruster 182 and a second thruster 184, and a propellant system 190. Furthermore, any combination of subsystems, units, or components of the spacecraft 100 involved in determining, generating, and/or supporting spacecraft propulsion (e.g., the mechanism control 130, the propulsion control 140, the flight computer 150, the power system 170, the thruster system 180, and the propellant system 190) may be collectively referred to as a propulsion system of the spacecraft 100.

The sensors and communications components 120 may several sensors and/or sensor systems for navigation (e.g., imaging sensors, magnetometers, inertial motion units (IMUs), Global Positioning System (GPS) receivers, etc.), temperature, pressure, strain, radiation, and other environmental sensors, as well as radio and/or optical communication devices to communicate, for example, with a ground station, and/or other spacecraft. The sensors and communications components 120 may be communicatively connected with the flight computer 150, for example, to provide the flight computer 150 with signals indicative of information about spacecraft position and/or commands received from a ground station.

The flight computer 150 may include one or more processors, a memory unit, computer readable media, to process signals received from the sensors and communications components 120 and determine appropriate actions according to instructions loaded into the memory unit (e.g., from the computer readable media). Generally, the flight computer 150 may be implemented any suitable combination of processing hardware, that may include, for example, applications specific integrated circuits (ASICs) or field programmable gate arrays (FPGAs), and/or software components. The flight computer 150 may generate control messages based on the determined actions and communicate the control messages to the mechanism control 130 and/or the propulsion control 140. For example, upon receiving signals indicative of a position of the spacecraft 100, the flight computer 150 may generate a control message to activate one of the thrusters 182, 184 in the thruster system 180 and send the message to the propulsion control 140. The flight computer 150 may also generate messages to activate and direct sensors and communications components 120.

The docking system 160 may include a number of structures and mechanisms to attach the spacecraft 100 to a launch vehicle 162, one or more payloads 164, and/or a propellant refueling depot 166. The docking system 160 may be fluidicly connected to the propellant system 190 to enable refilling the propellant from the propellant depot 166. Additionally or alternatively, in some implementations at least a portion of the propellant may be disposed on the launch vehicle 162 and outside of the spacecraft 100 during launch. The fluidic connection between the docking system 160 and the propellant system 190 may enable transferring the propellant from the launch vehicle 162 to the spacecraft 100 upon delivering and prior to deploying the spacecraft 100 in orbit.

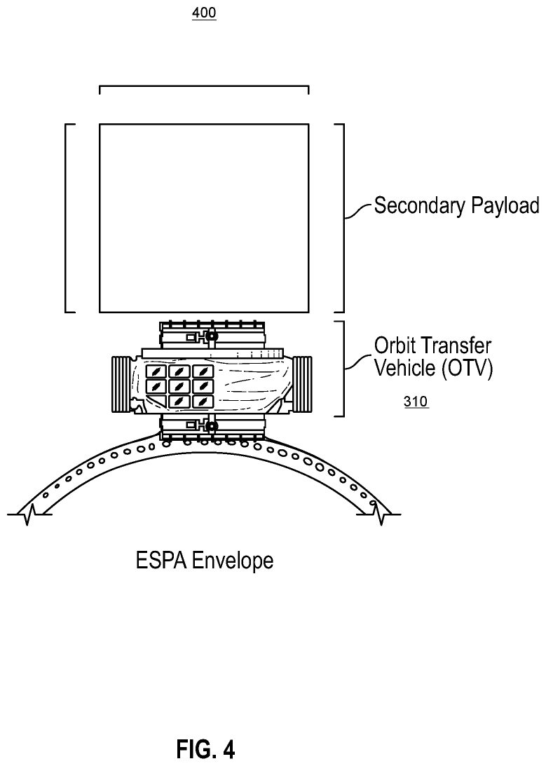

The power system 170 may include components (discussed in the context of FIGS. 4-7) for collecting solar energy, generating electricity and/or heat, storing electricity and/or heat, and delivering electricity and/or heat to the thruster system 180. To collect solar energy into the power system 170, solar panels with photovoltaic cells, solar collectors or concentrators with mirrors and/or lenses, or a suitable combination of devices may collect solar energy. In the case of using photovoltaic devices, the power system 170 may convert the solar energy into electricity and store it in energy storage devices (e.g, lithium ion batteries, fuel cells, etc.) for later delivery to the thruster system 180 and other spacecraft components. In some implementations, the power system 180 may deliver at least a portion of the generated electricity directly to the thruster system 180 and/or to other spacecraft components. When using a solar concentrator, the power system 170 may direct the concentrated (having increased irradiance) solar radiation to photovoltaic solar cells to convert to electricity. In other implementations, the power system 170 may direct the concentrated solar energy to a solar thermal receiver or simply, a thermal receiver, that may absorb the solar radiation to generate heat. The power system 170 may use the generated heat to power a thruster directly, as discussed in more detail below, to generate electricity using, for example, a turbine or another suitable technique (e.g., a Stirling engine). The power system 170 then may use the electricity directly for generating thrust or store electric energy as briefly described above, or in more detail below.

The thruster system 180 may include a number of thrusters and other components configured to generate propulsion or thrust for the spacecraft 100. Thrusters may generally include main thrusters that are configured to substantially change speed of the spacecraft 100, or as attitude control thrusters that are configured to change direction or orientation of the spacecraft 100 without substantial changes in speed. In some implementations, the first thruster 182 and the second thruster 184 may both be configured as main thrusters, with additional thrusters configured for attitude control. The first thruster 182 may operate according to a first propulsion technique, while the second thruster 184 may operate according to a second propulsion technique.

For example, the first thruster 182 may be a microwave-electro-thermal (MET) thruster. In a MET thruster cavity, an injected amount of propellant may absorb energy from a microwave source (that may include one or more oscillators) included in the thruster system 180 and, upon partial ionization, further heat up, expand, and exit the MET thruster cavity through a nozzle, generating thrust.

The second thruster 184 may be a solar thermal thruster. In one implementation, propellant in a thruster cavity acts as the solar thermal receiver and, upon absorbing concentrated solar energy, heats up, expands, and exits the nozzle generating thrust. In other implementations, the propellant may absorb heat before entering the cavity either as a part of the thermal target or in a heat exchange with the thermal target or another suitable thermal mass thermally connected to the thermal target. In some implementations, while the propellant may absorb heat before entering the thruster cavity, the thruster system 180 may add more heat to the propellant within the cavity using an electrical heater or directing a portion of solar radiation energy to the cavity.

The propellant system 190 may store the propellant for use in the thruster system 180. The propellant may include water, hydrogen peroxide, hydrazine, ammonia or another suitable substance. The propellant may be stored on the spacecraft in solid, liquid, and/or gas phase. To that end, the propellant system 190 may include one or more tanks. To move the propellant within the spacecraft 100, and to deliver the propellant to one of the thrusters, the propellant system may include one or more pumps, valves, and pipes. As described below, the propellant may also store heat and/or facilitate generating electricity from heat, and the propellant system 190 may be configured, accordingly, to supply propellant to the power system 170.

The mechanism control 130 may activate and control mechanisms in the docking system 160 (e.g., for attaching and detaching payload or connecting with an external propellant source), the power system 170 (e.g., for deploying and aligning solar panels or solar concentrators), and/or the propellant system (e.g., for changing configuration of one or more deployable propellant tanks). Furthermore, the mechanism control 130 may coordinate interaction between subsystems, for example, by deploying a tank in the propellant system 190 to receive propellant from an external source connected to the docking system 160.

The propulsion control 140 may coordinate the interaction between the thruster system 140 and the propellant system 190, for example, by activating and controlling electrical components (e.g., a microwave source) of the thruster system 140 and the flow of propellant supplied to thrusters by the propellant system 190. Additionally or alternatively, the propulsion control 140 may direct the propellant through elements of the power system 170. For example, the propellant system 190 may direct the propellant to absorb the heat (e.g., at a heat exchanger) accumulated within the power system 170. Vaporized propellant may then drive a power plant (e.g., a turbine, a Stirling engine, etc.) of the power system 170 to generate electricity. Additionally or alternatively, the propellant system 190 may direct some of the propellant to charge a fuel cell within the power system 190.

The subsystems of the spacecraft may be merged or subdivided in different implementations. For example, a single control unit may control mechanisms and propulsion. Alternatively, dedicated controllers may be used for different mechanisms (e.g., a pivot system for a solar concentrator), thrusters (e.g., a MET thruster), valves, etc. In the following discussion, a controller may refer to any portion or combination of the mechanism control 130 and/or propulsion control 140.

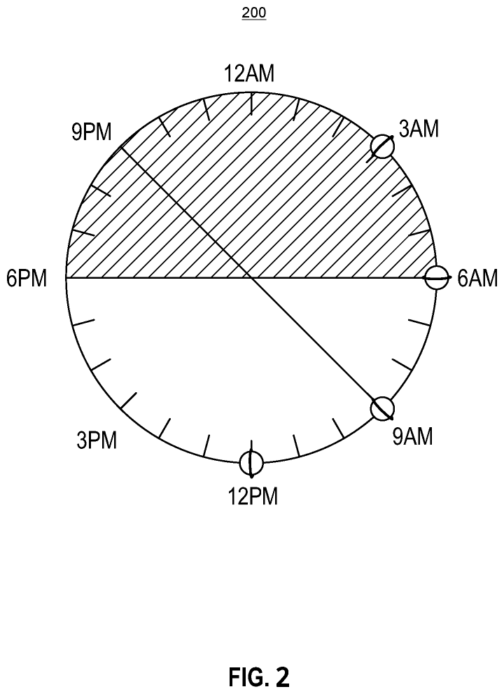

Next, FIG. 2 illustrates typical sun-synchronous orbits and sub orbits. The more common orbits are illustrated in a diagram 200 as 12 a.m. 3 a.m. 6 a.m. 9 a.m. etc. However, other demarcations on the clock face indicate sub orbits which may be useful for particular use cases or applications. Currently, it is not economically feasible to place a payload into a low earth orbit in one of the various less common sub orbits. However, pursuant to the various embodiments of the present systems and methods, such orbital transfers are now economically feasible. It should be noted that embodiments of the present disclosure are compatible with any low earth orbit (LEO) and other non-SSO orbital transfers or adjustments of any type of spacecraft or vehicle. Thus, for simplicity and breath herein, all satellites, spacecraft, and space vehicles will be referred to as a payload (PL).

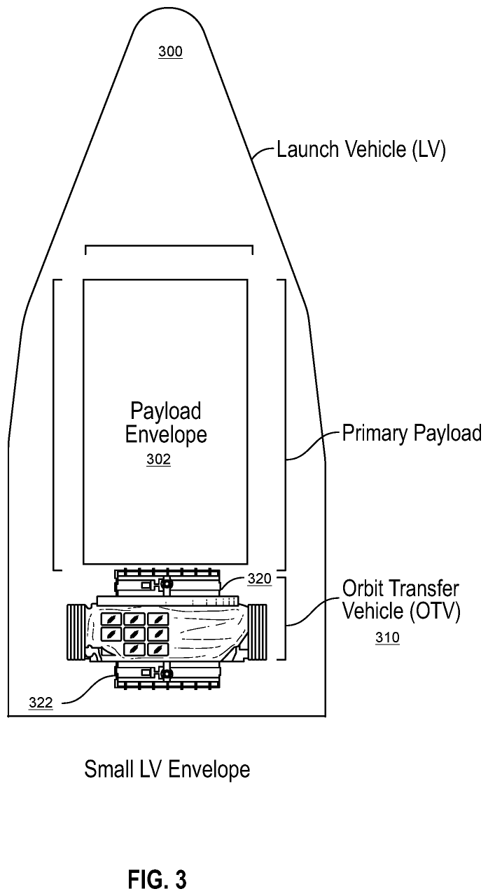

FIG. 3 schematically represents a primary payload envelope 302 for a launch vehicle 300, such as the launch vehicle 162 of FIG. 1 for example. FIG. 3 also illustrates in schematic fashion an orbit transfer vehicle or OTV 310 for achieving the transfer of a payload from an initial orbit to its ultimate orbit or sub orbit. The OTV 310 can be implemented as the spacecraft 100 described above, for example. Embodiments of this disclosure are configured to be compatible with other payload adapter systems and rings, such as Sherpa and LCROSS, as well as ESPA Star.

In FIG. 3, the OTV 310 is shown in its non-deployed format configuration with two payload adapters 320 and 322. Referring back to FIG. 1, the payload adapters 320 and 322 can be implemented in the docking subsystem 160 for example. The upper payload adapter 320 is compatible with the payload. The lower payload adapter 322 is compatible with whatever payload attachment system utilized by the launch vehicle. Thus, in FIG. 4, an ESPA ring payload attachment system is illustrated schematically. For simplicity, only one port of six on the ESPA ring is illustrated. Again, a secondary payload envelope is illustrated mounted on the ring by means of the OTV 310. Therefore, when the secondary payload is deployed by the LV, it is deployed in combination with the OTV 310 which serves as the transfer vehicle to its ultimate orbit or sub orbit.

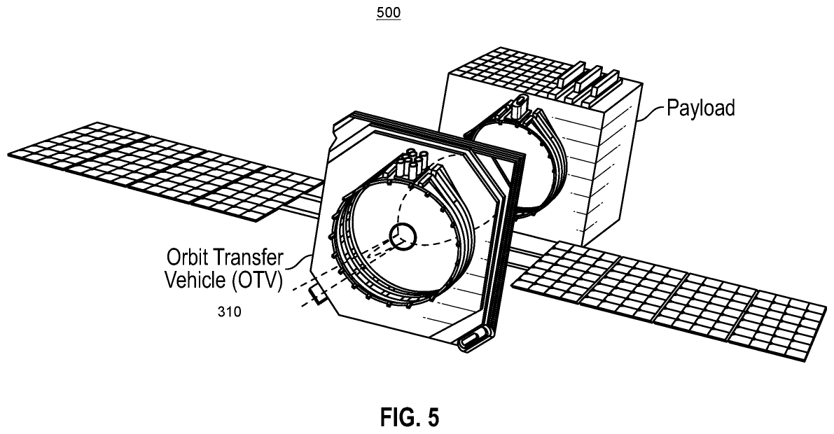

Such transfer is shown in a diagram 500 of FIG. 5. In this embodiment, the OTV 310 is provided with integrated solar power arrays and a propulsion mechanism, such as a water based microwave electrical thermal propulsion thruster (see the discussion of the example spacecraft 100 above). However, it will be noted that any suitable propulsion mechanism is compatible with the systems and methods of the present disclosure.

More generally, various configurations and dimensions for the OTV 310 are compatible with the present systems and methods. In one embodiment, the OTV 310 has a mass (without payload) of 80 kilograms and is capable of transferring a maximum payload mass of 250 kg. In such an embodiment, total impulse can be for example 100,000 N-S with a maximum delta-v of greater than 1 km per second for 50 kg payload. The OTV 310 can also be provided with a 3-axis stabilized electrothermal attitude control thrusters and custom and integrated avionics. Payloads can be attached to the OTV 310 using any standard 15 inch ring or 15 inch 4 point mount adapter. Custom adapter options are also possible. The OTV 310 can also be equipped with standard power connections for keep-alive operations of the payload during transfer.

In some embodiments, the OTV 310 can be mounted to the payload (e.g., the payload 164 of FIG. 1) at time of launch, as illustrated in FIGS. 3 and 4. However, the OTV 310 in other configurations can be mounted to the payload even after deployment at a particular LEO which may be an SSO or other orbit. Therefore, one or more space depots can be established at a particular common SSO or other LEO where payloads are typically off-loaded from the LV. The payload can then be mounted to an OTV for transfer to another orbit or sub orbit.

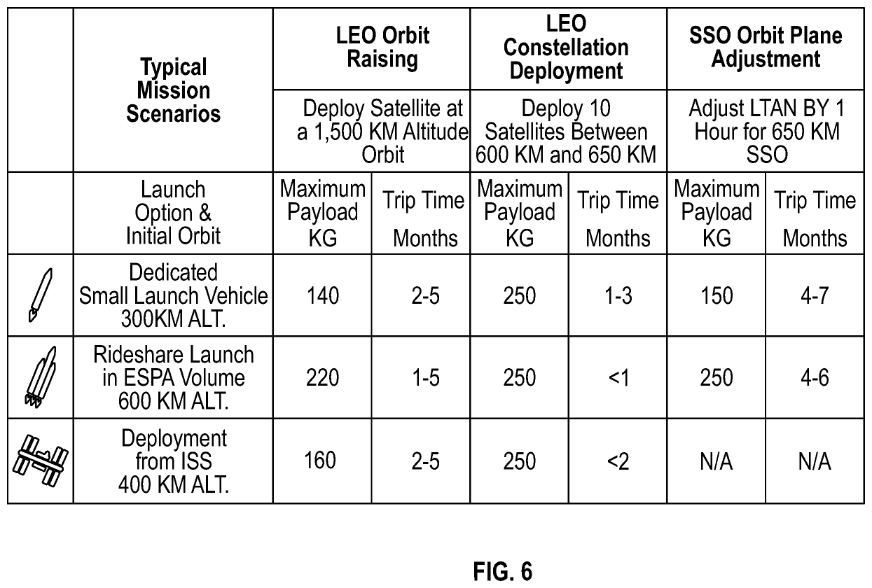

In view of the economic and technical advantages of the present system, various methods of orbital transfer are available. For example, as illustrated in the table of FIG. 6, payloads can be transferred from one orbit to a higher (or lower) orbit in a single trip; or, a constellation of multiple payloads can be transferred. Thus, as illustrated in FIG. 6, the present system and methods are compatible with small launch vehicles as well as rideshare launch vehicles having ESPA ring volume containing multiple payloads. The present systems and methods of orbital transfer are also compatible with deployment from the International Space Station or ISS.

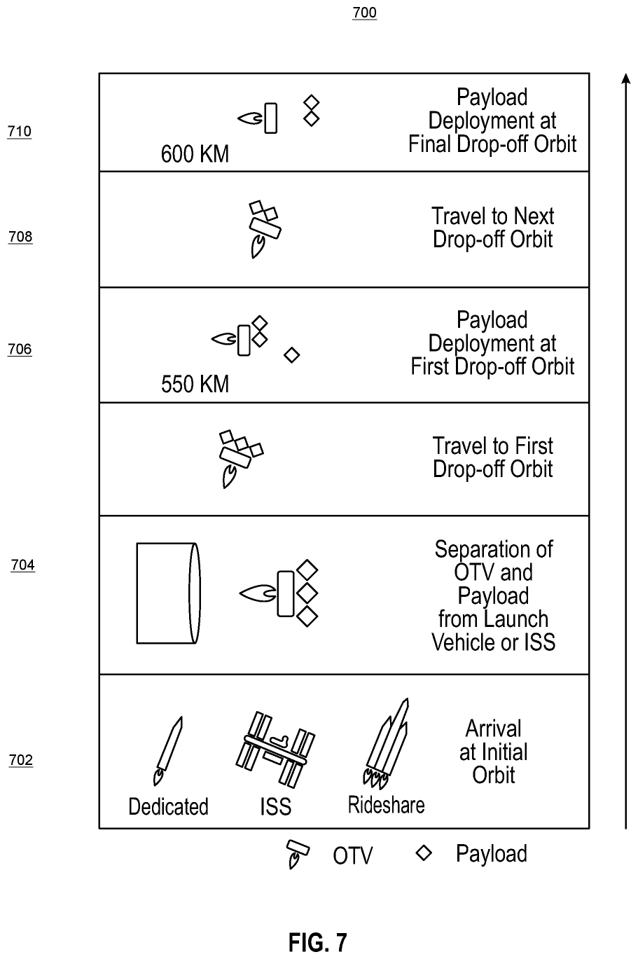

In this regard, FIG. 7 illustrates, in schematic fashion, the steps of a method 700 for typical orbital transfer utilizing the systems of the present disclosure. It will be recognized that FIG. 7 illustrates only a single method embodiment and that other methods are compatible with this disclosure. Thus, as viewed in FIG. 7 from bottom to top, the payload arrives 702 at an initial orbit, whether by dedicated launch vehicle, rideshare launch vehicle, or by deployment from the ISS. The payload and OTV (e.g., the OTV 310) separate 704 together from the LV or ISS. It should be noted that a single OTV can shuttle more than one payload to another orbit as illustrated in this diagram. Thus, the OTV travels 706 to a first orbital drop off point which is an orbit of 550 km in this example. The OTV then travels 708 to the next drop off orbit which is, for example, 600 kilometers, where it deploys 710 the final two payloads.

Therefore, the present systems and methods provide an in-space orbit transfer service for satellites and other payloads. Once in space, the OTV delivers the payload to one or multiple custom drop off orbits. The OTV enables the payload to be placed exactly in space where it is needed. In some implementations, the OTV may be expendable, but may also be reusable and capable of serving multiple missions while being refueled with water-based propellant in space. For example, FIGS. 9 and 9 illustrate one embodiment for providing propellant in space via a storage tank in the middle of an ESPA ring.

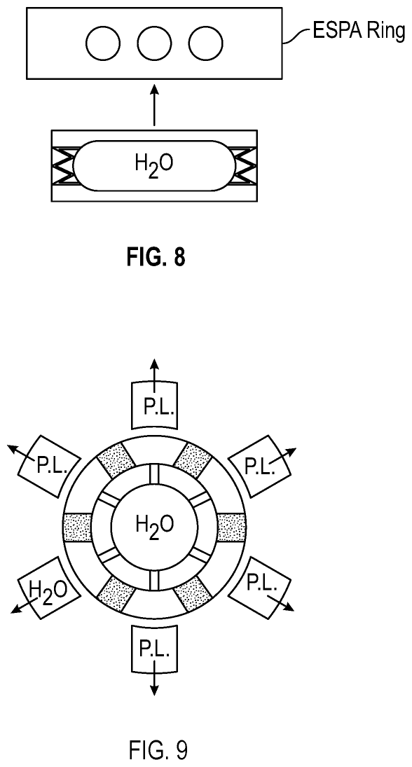

Thus, in connection with the present systems and methods, FIGS. 8 and 9 illustrate another embodiment in which propellant can be stored within the center of the payload adapter ring. This allows the OTV to have an immediate propellant source upon deployment. FIG. 8 is a side view of an adapter ring illustrating several ports and the water storage tank inserted into the center of the ring. This configuration is shown in the top or plan view of FIG. 9.

Generally speaking, most of the new LEO constellations will be spread through a variety of SSO planes. According to some implementations, regularly-scheduled LV flights to LEO, in conjunction with OTV 310 or similar transfer vehicle, together bring a shuttle service to almost any SSO orbit. Thus, as merely one example, a regularly-scheduled shuttle service to SSO may be based on the following schedule:

LTAN/LTDN every 9 months

| | | | | | |
|---|---|---|---|---|---|
| 6:00 | 7:00 | 8:00 | 9:00 | 10:00 | 11:00 |
| am | am | am | am | am | am |

LTAN/LTDN every 18 months

| | | | | | |
|---|---|---|---|---|---|
| noon | 1:00 | 2:00 | 3:00 | 4:00 | 5:00 |
| | am | am | am | am | am |

In addition, a similar method can be provided program for mid-inclined orbits. Features for all such regular shuttle services include, in one embodiment: (i) precise injection (100 m, 0.001° precision), (ii) delivery to orbital altitudes between 500 and 650 km; and (iii) precise orbit phasing injection.

This shuttle service may function in cooperation with an LV service or may be independent thereof. In one embodiment, the shuttle service may be optimized if utilized in conjunction with frequent LV flights to initial orbits and distribution across LTAN/LTDN as shown below. With this schedule, the payloads can be transferred, in one embodiment, in 3-6 months to their final destination.

| LTAN/LTDN | FREQUENCY |
|---|---|
| 9:00-10:00 | Every 6-9 months |
| 6:00-7:00 | Every 6-9 months |
| 12:00-3:00 | Every 9-12 months |

This service can support new and larger LV spacecraft. Thus, these methods are compatible with larger, reusable OTVs which, in turn, are compatible with ESPA Grande mass and volume envelopes and 24″ ESPA ports. In such embodiments, the present methods provide the flexibility to ferry both CubeSats and microsatellites and have enough volume for propellant for longer hops.

1. A method in a spacecraft operating as an orbital transfer vehicle for efficiently delivering payloads to respective orbits, the method comprising:
receiving, at the spacecraft, a payload from a launch vehicle; and
transferring the payload, using the spacecraft, to a second orbit in accordance with a predefined fixed schedule that specifies at least the second orbit and a plurality of times at which the spacecraft transitions between the first and the at least second orbit.

2. The method of claim 1, wherein:
the predefined fixed schedule is a first schedule; and
the receiving of the payload from the launch vehicle occurs in accordance with a second predefined fixed schedule.

3. The method of claim 1, wherein:
the first schedule includes a plurality of different orbits; and
the first schedule is generated in view of the second schedule to optimize delivery times for payloads from earth to the plurality of different orbits.

4. The method of claim 1, further comprising:
receiving, at the spacecraft, a plurality of payloads from the launch vehicle at a same time; and
transferring the plurality of payloads to a plurality of respective different orbits included in the predefined fixed schedule.

5. The method of claim 4, further comprising:
returning to the first orbit after delivering each of the plurality of payloads to the respective different orbits.

6. The method of claim 1, wherein the first orbit is a low earth orbit (LEO).

7. The method of claim 1, wherein the first orbit is a sun synchronous orbit (SSO).

8. The method of claim 1, wherein the predefined fixed schedule specifies a plurality of SSOs.

9. The method of claim 1, wherein the second orbit is at an altitude between 500 and 650 km.

10-13. (canceled)

14. A spacecraft comprising:
a thruster;
an adapter for removably attaching a payload; and
a controller configured to:
receive the payload from a launch vehicle, while the spacecraft is a first orbit; and
transfer the payload a second orbit in accordance with a predefined fixed schedule that specifies at least the second orbit and a plurality of times at which the spacecraft transitions between the first and the at least second orbit.

15. The spacecraft of claim 14, wherein:
the predefined fixed schedule is a first schedule; and
the receiving of the payload from the launch vehicle occurs in accordance with a second predefined fixed schedule.

16. The spacecraft of claim 14, wherein:
the first schedule includes a plurality of different orbits; and
the first schedule is generated in view of the second schedule to optimize delivery times for payloads from earth to the plurality of different orbits.

17. The spacecraft of claim 14, wherein the controller is further configured to:
receive a plurality of payloads from the launch vehicle at a same time; and
transfer the plurality of payloads to a plurality of respective different orbits included in the predefined fixed schedule.

18. The spacecraft of claim 17, wherein the controller is further configured to:
return to the first orbit after delivering each of the plurality of payloads to the respective different orbits.

19. The spacecraft of claim 14, wherein the first orbit is a low earth orbit (LEO).

20. The spacecraft of claim 14, wherein the first orbit is a sun synchronous orbit (SSO).

21. The spacecraft of claim 14, wherein the predefined fixed schedule specifies a plurality of SSOs.

22. The spacecraft of claim 14, wherein the second orbit is at an altitude between 500 and 650 km.
